(19) United States
(12) Patent Application Publication
(10) Pub. No.: US 2012/0173726 A1
(43) Pub. Date: Jul. 5, 2012

(54) Apparatus and Method for Resource Contention

(75) Inventors: Remek Zajac, London (GB); Viki Turner, London (GB); John Imhofe, London (GB)

(73) Assignee: NOKIA CORPORATION, Espoo (FI)

(21) Appl. No.: 13/380,507

(22) PCT Filed: Jun. 28, 2010
(86) PCT No.: PCT/IB2010/052933

§ 371 Date: Mar. 12, 2012

(30) Foreign Application Priority Data
Jun. 30, 2009 (GB) 0911345.7

(51) Int. Cl. G06F 15/173

(52) U.S. Cl. 709/225

(57) ABSTRACT

An apparatus and a method. The apparatus comprises a resource access module arranged to: receive a request one of a plurality of clients for access to a resource in which the clients each include an associated priority; establish a resource access point to provide access to the resource and to associate the client priority with the resource access point; establish a resource manager to manage access to the resource; and pass the priority associated with the resource access point to the manager; wherein in the event of contention for a resource by two or more clients, the resource manager is further arranged to resolve the contention, based on the passed priorities, to enable the resource access point having the highest associated priority to access the resource.

### TECHNICAL FIELD

This invention relates to an apparatus and a method for resource contention.

### BACKGROUND TO THE INVENTION

Computing devices include different technologies for communication with other devices. For example, a mobile telephone may include radio technologies such as WiFi, Bluetooth, GPRS as well cable technologies such as USB. Computing devices also include a large number of applications and services which use these technologies to communicate with other devices. For example, a mobile telephone may include a VoIP application which enables voice calls to be made over an IP connection which is established using WiFi or GPRS. Another example is an email application which can automatically check for emails using either WiFi or GPRS.

Resources such as WiFi and GPRS are limited. They can only carry a certain amount of data at any one time. In some cases, only one application or service can use a resource at any one time. For example, a typical WLAN chip can only be associated with one SSID at a time. If two applications want to associate themselves with different SSIDs, a contention occurs. Another example is where the available bandwidth on a particular link is required by a single application. If two applications require use of that bandwidth, a contention occurs.

### SUMMARY OF EXAMPLES OF THE INVENTION

An example of the invention provides an apparatus comprising: a resource access server arranged to: receive requests from a plurality of clients for access to resources, in which each client includes an associated priority; establish a resource manager for a resource, in response to a request for access to that resource; and pass client priorities to the resource; wherein the resource manager is further arranged to resolve contention for a resource by two or more clients, based on the client priorities, to enable the client having the highest associated priority to access the resource.

The resource access server may be further arranged to provide a client with access to a resource if the resource is not in use.

The resource access server may be further arranged to refuse a client access to a resource if the resource is in use.

The resource access server may be further arranged to notify the resource manager that there is a contention for the resource.

When a first client is using a resource and a second client requests access to the resource, the resource manager may be further arranged compare the priority of the first client with the priority of the second client.

If the second client has a higher priority than the first client, the resource manager may be arranged to give the resource to the second client, else inform the second client that the resource is in use.

The resource manager may be arranged to receive notifications from a client the client has finished using a resource.

The resource manager may be further arranged, following contention for a resource, to notify a client when the resource becomes available.

The resource server may be further arranged to establish an access point in response to a client request.

An access point may be arranged to provide an interface to a resource and has an associated priority.

An access point may be arranged to take the priority of a client.

An access point may be arranged to be shared by two clients and to take the priority of the client having the highest priority.

An access point which is shared by two clients may be further arranged to notify the resource manager of a change in priority when a new client joins or leaves the access point.

The resource access server may be a communications server and the resources may be communications resources.

The communications server may be further arranged to establish a plurality of access points each representing a lower level service.

Each access point may be arranged to take the priority of the respective client.

The access points may be further arranged to pass priorities from one access point to another.

Resource contention may occur at any layer of the stack and the communications server may be arranged to establish a resource manager at any layer of the stack.

The resource manager may be further arranged to notify a client if it is forced to relinquish a resource.

The resource manager may be further arranged to notify a client when a previously relinquished resource becomes available.

In a further example, the invention provides a computing device comprising: the apparatus described above; a processor for carrying out instructions stored on the device; a plurality of resources; and a plurality of clients.

Another example of the invention provides a method comprising: receiving a request from a first client for access to a resource, the request including a priority associated with the first client; passing the first client priority to a resource manager; comparing the priority of a second client to the priority of the first client; if the resource is in use by the second client; enabling the first client to access the resource if the first client has a higher priority than the second client, else allowing the second client to continue using the resource.

Another example of the invention provides a computing device which may comprise: a memory, arranged to store instructions; a processor, arranged to carry out said instructions; a plurality of said clients, stored in said memory.

A further example of the invention provides a computer program or a suite of computer programs arranged such that when executed by a computer they cause the computer to operate in accordance with the method described above.

A further example of the invention provides a computer readable medium storing the computer program, or at least one of the suites of computer programs.

A further example of the invention provides an operating system for causing a computing device to operate in accordance with a method described above.

A further example of the invention provides a device substantially as described herein and as shown in FIGS. 1 to 10.

This summary provides examples of the invention which are not intended to be limiting on the scope of the invention. The features of the invention described above and recited in the claims may be combined in any suitable manner. The combinations described above and recited in the claims are not intended to limit the scope of the invention.

Features and advantages associated with the examples of the invention will be apparent from the following description of some examples of the invention.

### BRIEF DESCRIPTION OF THE DRAWINGS

Examples of the invention are hereinafter described with reference to the accompanying diagrams where:

FIG. 1 is a schematic diagram of the components of a mobile telephone in an example of the invention;

FIG. 2 is a functional diagram showing some components of the device shown in FIG. 1;

FIG. 3 is a flow chart showing a method in an example of the invention;

FIG. 4 is a further functional diagram showing some components of the device shown in FIG. 1;

FIG. 5 is a flow chart showing a method in an example of the invention;

FIG. 6 is a flow chart showing a method in an example of the invention;

FIG. 7 is a flow chart showing a method in an example of the invention;

FIG. 8 is a further functional diagram showing some components of the device shown in FIG. 1;

FIG. 9 is a flow chart showing a method in an example of the invention; and

FIG. 10 is a flow chart showing a method in an example of the invention.

### DESCRIPTION OF EXAMPLES OF THE INVENTION

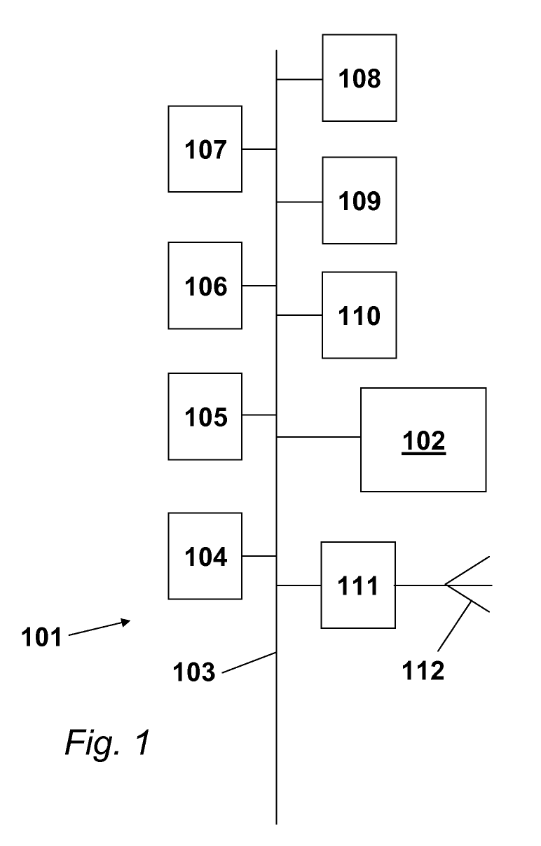

The following example of the invention is described in the context of a mobile telephone. It will be appreciated that examples of the invention may include other computing devices. FIG. 1 is a schematic diagram showing some of the components of a mobile telephone 101. The components of the mobile telephone 101 include a processor 102, which is arrange to carry out instructions stored as computer programs on the telephone. The telephone 101 also includes a system bus 103 which connects the processor 102 to other components of the device. The bus 103 allows the components to communicate with each other. Here, the components are shown to communicate via a single system bus 103, however, in practice, the mobile telephone 101 may include several buses to connect the various components.

The telephone 101 also includes an speaker 104, a microphone 105, a keypad 106 and a display 107. These components may also include respective device controllers. The mobile telephone 101 also memory components including a ROM 108, a RAM 109 and a storage device 110. The storage device may be an internal hard drive or a removable storage device such as a flash memory card. The ROM 108 has an operating system stored thereon. The operating system is for controlling the operation of the device. The RAM 109 is used while the device is switched on to store temporary data. The telephone 101 also includes a radio 111 and an antenna 112. The radio 111 and antenna 112 allow the telephone to communicate with a mobile phone network in a manner familiar to the person skilled in the art.

This description of the components of a telephone 101 is one example of the manner in which the components may be arranged. Many variations are possible, including different components and different arrangements of those components. The invention is not limited to any particular set of components nor to any particular combination of those components. Advances in computing device technology may result in certain components being replaced by others which perform the same function. Such a device could also embody the invention.

The mobile telephone 101 includes an operating system (OS) which is stored in ROM 108. The OS may be the Symbian OS. The device also includes other software applications which may be stored in ROM or which may be stored in the storage device 110. The processor 102 is arranged to execute instructions of the OS and of the applications. Execution of these instructions causes mobile device 101 to carry out particular functions by controlling the various hardware components of the device.

One example of the invention relates PDP (packet data protocol) context contention. A PDP context is a packet data connection in a mobile phone network. It exists between a mobile telephone and the network for exchanging data packets. A limited number of PDP contexts may be established between a mobile telephone and a network. This limit is a technical one (devices can only establish a certain number of contexts) and a commercial one (service providers limit the number of PDP contexts which can be established at any one time by a device). In addition, mobile telephones typically have several different applications which are capable of offering services over a PDP context. As a result of these factors, two or more services may each require a separate PDP context, when the device can only provide a single PDP context (i.e. they can not share PDP contexts). This example of the invention provides a mechanism for handing PDP context contention. The OS includes a communications server which is used by clients for establishing communications over a PDP context. The communications server is for building, maintaining and tearing down communications stacks for clients.

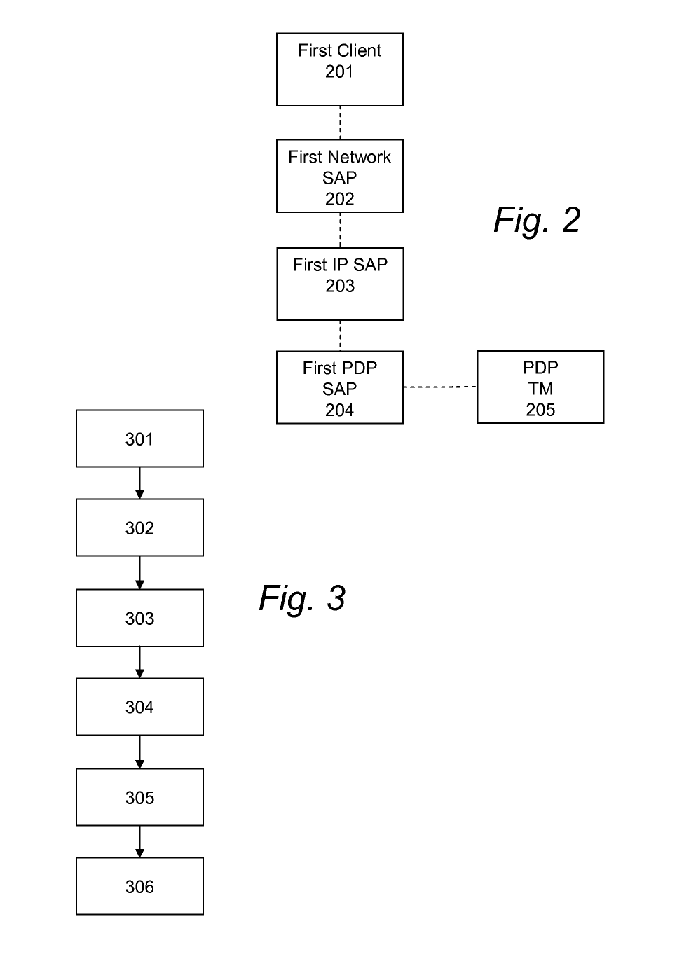

A first example is shown in FIG. 2. The mobile telephone 101 is limited to establishing a single PDP context. Access to PDP contexts is provided through the communications server, as noted above. The mobile telephone 101 includes a first client 201 which is for establishing a first service over a PDP context. The client 201 is assigned a priority. The highest available priority is zero. There is no limit to the priority. The higher the priority number the lower the priority of the service. In the present case the first client 201 is assigned a priority of three.

The method of establishing a PDP context in this example is shown in FIG. 3. The first client 201 sends a request to the communications server to establish a PDP context (block 301). The request includes the client priority. The communications server establishes the communications stack layer by layer. In the present example, a network layer, an IP layer and a PDP layer must be established. Each layer is a service access point (SAP) for the upper adjacent layer. A first network SAP 202 is established by the communications server and a priority of three is attached to it (block 302). A join request is sent to the IP layer by the first network SAP 202 and a first IP SAP 203 is established (block 303). A priority of three is attached to the first IP SAP 203. A join request is then sent to the PDP layer by the first IP SAP 203 and a first PDP SAP 204 is established having a priority of three (block 304). A PDP context is then established for use by the first client 201 (block 305). The first PDP SAP 204 acts as an access point to the PDP context for the first client 201. The PDP layer also includes a PDP Tier Manager (TM) 205 which managers contention in the PDP layer. In this case there is no contention so the first PDP SAP 204 able to establish a PDP context. The PDP TM 205 is notified of the first PDP SAP 204 priority (block 306).

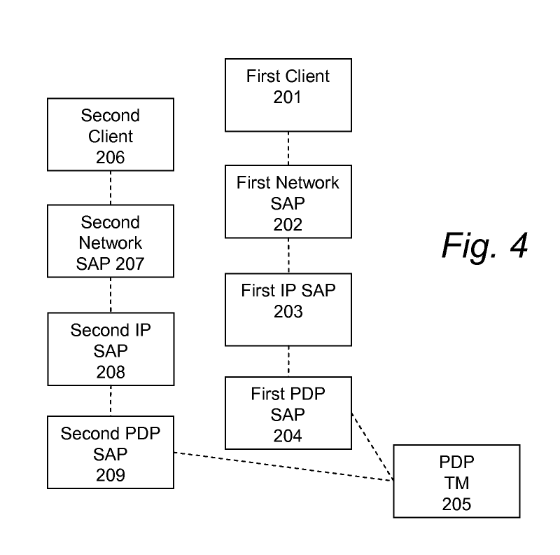

A second example is shown in FIG. 4. Here the mobile telephone 101 also includes a second client 206 which is for establishing a second service over a PDP context. The second client 206 is assigned a priority of one. In this case, the first client 201 already has a service established over a PDP context via the first PDP SAP 204.

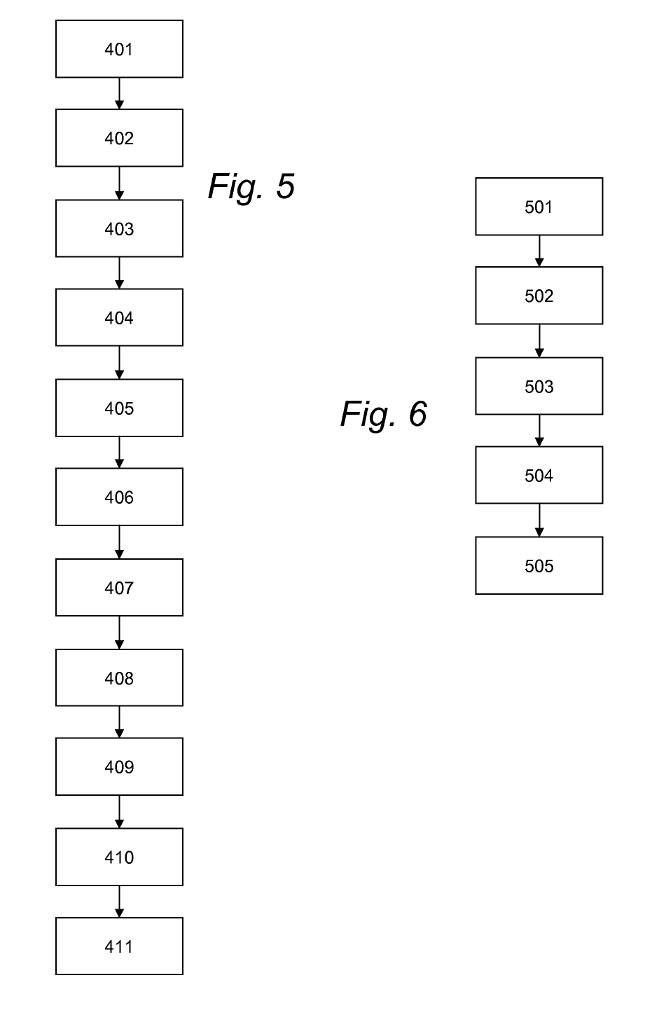

The method of establishing a PDP context in this example is shown in FIG. 5. Firstly, the second client 206 sends a request to the communications server to establish a PDP context (block 401). The request includes the client priority. The communications server establishes a second network SAP 207 and attaches the a priority of one to the second network SAP 207 (block 402). The second network SAP 207 sends a join request to the IP layer and a second IP SAP 208 is established having a priority of one (block 403). The second IP SAP 208 sends a join request to the PDP layer (block 404). A second PDP SAP 209 is established having a priority of one (block 405). As a PDP context is already established, the second PDP SAP 209 returns an error (block 406). The second PDP context then sends a contention request to the PDP TM 205 (block 407). The PDP TM 205 compares the priority of the second PDP SAP 209 with the priority of the first PDP SAP 204 (block 408). In this case, the new service has a higher priority than the existing service. The PDP TM 205 sends a signal to the first PDP SAP 204 instructing it to stop the data connection (block 409). The first PDP SAP 204 stops the connection and signals up the stack that the connection is no longer available (block 410). The PDP TM 205 also informs the first client 201 that the connection is no longer available (block 411). The first client 201 then monitors connection availability notifications made by the PDP TM 205. The PDP TM 205 also notifies the second PDP SAP 209 that the contention has been resolved and that it can retry the connection. The second PDP SAP 209 then establishes a PDP context.

The method of stopping the PDP context described in connection with FIG. 5 is shown in FIG. 6. When the second client 206 has finished with the connection, the second network SAP 207 sends a signal to the second IP SAP 208 to stop (block 501). The second IP SAP 208 sends a signal to the second PDP SAP 209 to stop and the PDP context is stopped (block 502). The second PDP SAP 209 sends a signal to the PDP TM 205 indicating that the PDP context is available (block 503). The PDP TM 205 then sends an availability notification to the first client 201 (block 504). The first client 201 then restarts its connection as described above in connection with FIG. 3 (block 505).

In a third example, the elements are the same as shown in FIG. 4, however the second client 206 is assigned a priority of three and the first client 201 is assigned a priority of one. In this case, the first client 201 already has a service established over a PDP context.

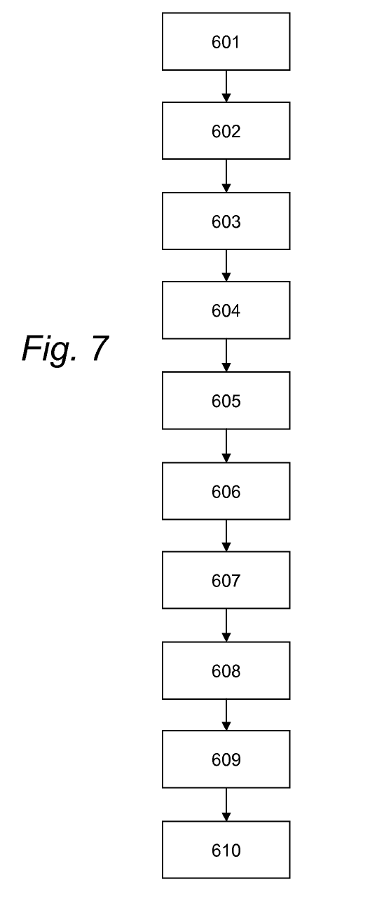

The method of establishing a PDP context in this example is shown in FIG. 7. Firstly, the second client 206 sends a request to the communications server to establish a PDP context (block 601). The communications server establishes a second network SAP 207 and attaches the a priority of three to the second network SAP 207 (block 602). The second network SAP 207 sends a join request to the IP layer and a second IP SAP 208 is established having a priority of three (block 603). The second IP SAP 208 sends a join request to the PDP layer (block 604). A second PDP SAP 209 is established having a priority of three (block 605). As a PDP context is already established the second PDP SAP 209 returns an error (block 606). The second PDP context then sends a contention request to the PDP TM 205 (block 607). The PDP TM 205 compares the priority of the second PDP SAP 209 with the priority of the first PDP SAP 204 (block 608). In this case, the new service has a lower priority than the existing service. The PDP TM 205 sends a signal to the second PDP SAP 209 indicating that the connection has failed (block 609). The second PDP SAP 209 reports back to the second client 206 that the connection has failed (block 610). The second client 206 may then monitor availability notifications from the PDP TM 205 and retry when the PDP context becomes available.

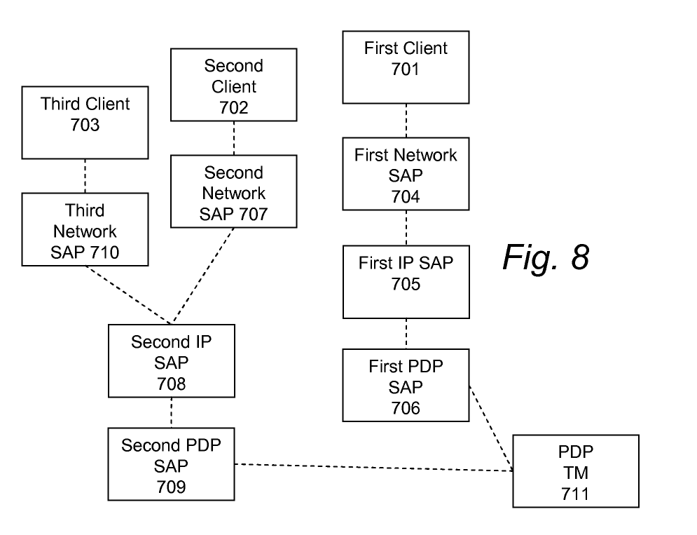

A fourth example is shown in FIG. 8. In this example, certain clients are able to share PDP contexts. However, there still exists the requirement to resolve resource contention when clients which require different PDP contexts need to use a PDP context at the same time. There also needs to be a mechanism to determine what priority a SAP should take when it is being shared by shared by two upper adjacent SAPs.

In this example, there are three clients wishing to use a PDP context. The first client 701 has a priority of three, the second client 702 has a priority of four and the third client 703 has a priority of one. In this example, the first client 701 has already established a PDP context. A first network SAP 704, a first IP SAP 705 and a first PDP SAP 706 are established, each having a priority of three. The second client 702 has previously attempted to establish a PDP context but was rejected because, a) it requires a separate PDP context to the first client 701; and b) it has a lower priority than the first client. This procedure would have occurred in a manner similar to that described above in FIG. 7. The third client 703 now wishes to establish a PDP context. The third client is able to share a PDP context with the second client 702. In this case the communications server has already established a second network SAP 707, a second IP SAP 708 and a second PDP SAP 709 for the second client 702. The second client 702 is currently watching availability notification in case the first client 701 gives up the PDP context.

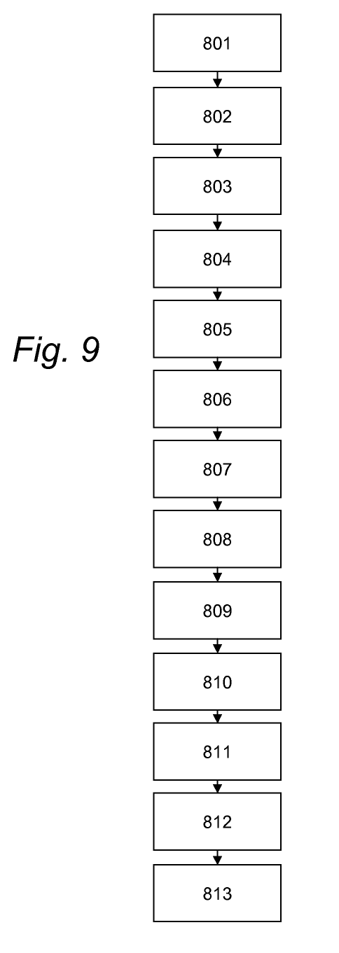

The method of establishing a PDP context in this example is shown in FIG. 9. The third client 703 first sends a request to the communications server (block 801). The request includes the client priority. The communications server detects that the third client 703 may use the same PDP context as the second client 702 (block 802). In particular, in this case, the third client requires its own network SAP, but may share the IP SAP and PDP SAP with the second client 702. The communications server establishes a third network SAP 710 for the third client 703 (block 803). The third network SAP 710 is then attached to the second IP SAP 708 (block 804). The third network SAP 710 sends a join instruction to the second IP SAP 708 together with the priority of one (block 805). The second IP SAP 708 changes its priority from four to one to reflect the priority of the third client 703 (block 806). The second IP SAP 708 then sends a priority change notification to the second PDP SAP 709 as well as a join instruction (block 807). The second PDP SAP 709 returns an error because a PDP context is already established (block 808). The second PDP SAP 709 notifies the PDP TM 711 that a contention has occurred (block 809). The PDP TM 711 compares the priority of the existing service with the priority of the new service (block 810). In this case, the new service has a higher priority than the existing service. The PDP TM 711 sends a signal to the first PDP SAP 706 instructing it to stop the data connection (block 811). The first PDP SAP 706 stops the connection (block 812). The PDP TM 711 also informs the second PDP SAP 709 that the contention has been resolved and that it can retry the connection (block 812). The second PDP SAP 709 then establishes a PDP context (block 813). The second client 702 (priority four) and the third client 703 (priority one) may then use the PDP context. The PDP TM 711 also sends a notification to the first client 701 notifying it that the PDP context is not available. The first client 701 monitors these notification and when the PDP context becomes available, it will try to restart its connection.

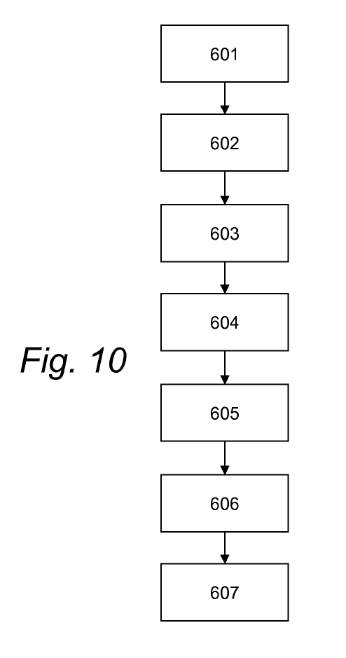

The method of stopping the PDP context described in connection with FIG. 9 is shown in FIG. 10. When the third client 703 has finished with the connection, the second third network SAP 710 notifies the second IP SAP that it is leaving (block 901). The second IP SAP 708 changes its priority to four to reflect the priority of the second client 702 and notifies the second PDP SAP 709 that it should change priority to four (block 902). The second PDP SAP 709 notifies the PDP TM 311 that its priority has changes to four (block 903). The PDP TM 711 notifies the first client 701 that the resource has become available and that it should try again (block 904). The first client 701 may then try to establish a PDP context in the manner described above in connection with FIG. 3 (block 905). A contention process will be established as described in connection with FIG. 5 (block 906). In this case the first client 701 will gain the PDP context as it has a higher priority than the second client 702 (block 907).

The above examples of the invention describe a software implementation of the invention. Other examples of the invention include a hardware only implementation.

A example of the invention includes a component on a chip which provides the functionality described above in connection with the software implementation.

An example of the invention is an apparatus as defined in the claims. This apparatus may be a component provided as part of a chip on an electronic circuit board. Alternatively the apparatus may be a chip on an electronic circuit board. As a further alternative, the apparatus may be a computing device, such as a mobile phone. The features defined in the claims may be implemented in hardware. Alternatively, the features may be implemented using software instructions which may be stored in a memory provided on the component, chip or computing device.

A further example of the invention provides an apparatus comprising: means for receiving requests from a plurality of clients for access to resources, in which each client includes an associated priority; means for establishing a means for resource management, in response to a request for access to that resource; and means for passing client priorities to the resource; wherein the means for resource management is further arranged to resolve contention for a resource by two or more clients, based on the client priorities, to enable the client having the highest associated priority to access the resource.

Resource contention is when two or more clients compete for a limited resource. This may be a unitary limit. A particular resource can only service one client at a time. Alternatively is may be a continuous resource, such as bandwidth, in which only a certain amount of that resource is available for use by clients. For example, if two clients require use of the full bandwidth of a communications link, a contention occurs. If two clients require use of a PDP context over a link in which only a single PDP context can be established, a PDP context occurs. If two clients require use of a WLAN chip to access different SSIDs, a contention occurs.

An access point provides access to lower level services in a comms stack. For example, an access point in the network layer provides access to services provided by the IP layer. Generally speaking, an access point is a node in a layer which provides higher level clients with access to lower layer services

In general terms, the above examples show that the winner (i.e. client) is selected based on the information that is meaningful at a remote layer of the stack. The examples show that this information can be passed through the stack to enable a decision to be made close to the resource.

Various modifications, changes, and/or alterations may be made to the above described examples to provide further examples which use the underlying inventive concept, falling within the spirit and/or scope of the invention. Any such further examples are intended to be encompassed by the appended claims.

1.-26. (canceled)

27. An apparatus comprising:
a resource access server configured to:
receive one or more requests from a plurality of clients for access to resources, the one or more requests include priority associated with one or more clients;
establish a resource manager for a resource, in response to a request for access to the resource; and
pass client priorities to the resource manager; wherein the resource manager is configured to resolve contention for the resource by two or more clients, based on the client priorities, to enable the client having the highest associated priority to access the resource.

28. An apparatus according to claim 27, wherein the resource access server is further configured at least to:
provide a client with access to the resource if the resource is not in use; or refuse a client access to the resource if the resource is in use.

29. An apparatus according to claim 27, wherein the resource access server is further configured to notify the resource manager if there is a contention for the resource.

30. An apparatus according to claim 29, wherein the resource manager is further configured to, following contention for a resource, notify the client if the resource becomes available.

31. An apparatus according to claim 27, wherein the resource access server is further configured to establish an access point in response to the request from the client, and wherein the access point is configured to provide an interface to the resource and has an associated priority.

32. An apparatus according to claim 31, wherein the access point is further configured at least to:
take the priority of the respective client;
be shared by two clients and to take the priority of the client having the highest priority; or notify the resource manager of a change in priority if a client joins or leaves the access point.

33. An apparatus according to claim 27, wherein the resource access server is a communications server and the resources are communications resources.

34. An apparatus according to claim 27, wherein the resource manager is further configured to notify a client if the client is forced to relinquish a resource.

35. An apparatus according to claim 34 wherein the resource manager is further configured to notify the client if a previously relinquished resource becomes available.

36. A method comprising:
receiving one or more requests from a plurality of clients for access to resources, the one or more requests include priority associated with one or more clients;
establishing a resource manager for a resource, in response to a request for access to the resource; and
passing client priorities to the resource manager; wherein the resource manager is configured to resolve contention for the resource by two or more clients, based on the client priorities, to enable the client having the highest associated priority to access the resource.

37. A method according to claim 36, further comprising at least:
providing a client with access to the resource if the resource is not in use; or
refusing a client access to the resource if the resource is in use.

38. A method according to claim 37 further comprising notifying the resource manager if there is a contention for the resource.

39. A method according to claim 38 further comprising, following contention for a resource, notifying the client if the resource becomes available.

40. A method according to claim 36, further comprising establishing an access point in response to the request from the client, wherein the access point is configured to provide an interface to the resource and has an associated priority.

41. A method according to claim 36, wherein the resources are communications resources.

42. A method according to claim 36 further comprising notifying a client if the client is forced to relinquish a resource.

43. A method according to claim 42 further comprising notifying the client if a previously relinquished resource becomes available.

44. A computer program product comprising at least one program instruction, which when executed by an apparatus, cause the apparatus at least to perform:
receive requests from a plurality of clients for access to resources, the requests include priority associated with clients;
establishing a resource manager for a resource, in response to a request for access to the resource; and
pass client priorities to the resource manager; wherein the resource manager is configured to resolve contention for the resource by two or more clients, based on the client priorities, to enable the client having the highest associated priority to access the resource.

45. A computer program product according to claim 44, wherein the computer program code further causes the apparatus to establish an access point in response to the request from the client, wherein the access point is configured to provide an interface to the resource and has an associated priority.

46. A computer program product according to claim 44, wherein the resources are communications resources.
